(19) United States
(12) Patent Application Publication
(10) Pub. No.: US 2024/0248971 A1
(43) Pub. Date: Jul. 25, 2024

(54) SAME PERSON DETECTION OF END USERS BASED ON INPUT DEVICE DATA

(71) Applicant: SardineAI Corp., Miami, FL (US)

(72) Inventors: Srikant Rao, Pioneer, CA (US); Andrew Tausz, Toronto (CA); Kazuki Nishiura, Berkeley, CA (US); Jeffrie Joshua Lazarus George, Georgetown, TX (US)

(21) Appl. No.: 18/099,793

(22) Filed: Jan. 20, 2023

(51) Int. Cl. G06F 21/32; G06F 21/34

(52) U.S. Cl. CPC G06F 21/32; G06F 21/34

(57) ABSTRACT

The present technology includes receiving behavioral data from a user from a user device, wherein the behavioral data includes behavioral biometrics of the user obtained from one or more sensors of the user device when the user is performing an interaction with a service executing on the user device; comparing the behavioral data and a biometric fingerprint associated with a user profile; and generating, based on the comparison between the behavioral data and the biometric fingerprint, a score indicative of a likelihood that an identity of the user is associated with the user profile.

### TECHNICAL FIELD

The present technology pertains to identifying an identity of an end user and, more particularly to, determining whether the end user is the same person that has previously accessed a service based on event data obtained while the end user interacts with a graphical user interface of a service.

### BACKGROUND

Interactions between people are based on knowledge of who each party is. In physical interactions, people can verify the identity of another person. More specifically, people can utilize various different senses to determine whether the other person is who they say they are. For example, the person can look at a driver's license, ask specific questions, hear the person's voice, etc. Even if one cannot fully determine if the person is who they say they are, people can at least have a general idea of the actual person they are interacting with.

This contrasts with the digital world, where we have little insight into who is truly behind an avatar or an account. As the world becomes increasingly involved with the digital world, users are more frequently performing interactions online. For example, users regularly fill out forms online for various reasons. As another example, users post content or posts on social media networks. Furthermore, users may utilize a variety of different types of devices to access these different services. For example, users use computers, mobile phones, tablets, etc.

When users interact online, service providers and other people are not able to ascertain a true identity of the user. For example, a user signing up online for an account with a clothing retail store may potentially provide a different or false identity. The clothing retail store has no way to determine whether the information provided is true.

### BRIEF DESCRIPTION OF THE DRAWINGS

Details of one or more aspects of the subject matter described in this disclosure are set forth in the accompanying drawings and the description below. However, the accompanying drawings illustrate some typical aspects of this disclosure and are therefore not to be considered limiting of its scope. Other features, aspects, and advantages will become apparent from the description, the drawings and the claims.

FIG. 1 illustrates an example system for frictionless interactions between a user and a service in accordance with some aspects of the present technology.

FIG. 2 illustrates an aspect of the subject matter in accordance with one embodiment.

FIG. 3A illustrates an example webpage or app in accordance with some aspects of the present technology.

FIG. 3B illustrates an example webpage or app in accordance with some aspects of the present technology.

FIG. 3C illustrates an example webpage or app in accordance with some aspects of the present technology.

FIG. 4 illustrates an example output of a subject evaluation service in accordance with some aspects of the present technology.

FIG. 5 illustrates a method 500 for determining whether a device that an end user is using to perform an interaction with a service is associated with a claimed person having a user profile in accordance with some aspects of the present technology.

FIG. 6 illustrates a method 600 for determining whether an end user performing an interaction with a service is actually a claimed person associated with a user profile in accordance with some aspects of the present technology.

FIG. 7 illustrates a method 700 for training a machine learning model to determine whether behavioral data inputs are inputted by a user of a user profile associated with the biometric fingerprint in accordance with some aspects of the present technology.

FIG. 8 illustrates a method for training a machine learning model in accordance with some aspects of the present technology.

FIG. 9 shows an example of a system for implementing certain aspects of the present technology.

### DETAILED DESCRIPTION

Various examples of the present technology are discussed in detail below. While specific implementations are discussed, it should be understood that this is done for illustration purposes. A person skilled in the relevant art will recognize that other components and configurations may be used without parting from the spirit and scope of the present technology. In some instances, well-known structures and devices are shown in block diagram form in order to facilitate describing one or more aspects. Further, it is to be understood that functionality that is described as being carried out by certain system components may be performed by more or fewer components than shown.

Interactions between people are based on knowledge of who each party is. In physical interactions, people can verify an identity of another person. More specifically, people can utilize various different senses to determine whether the other person is who they say they are. For example, the person can look at a driver's license, ask specific questions, hear the person's voice, etc.

As the world becomes increasingly involved with the digital world, users are more frequently performing interactions online. For example, users regularly fill out forms online for various reasons. As another example, Furthermore, users may utilize a variety of different types of devices including, but not limited to, a computer, a mobile phone, a tablet, etc.

When users interact online, service providers are not able to ascertain a true identity of the user. For example, a user signing up online for an account with a clothing retail store may potentially provide a different or false identity. The clothing retail store has no way to determine whether the information provided is true.

A more malicious scenario may be a user or fraudster attempting to impersonate another person to access or set up an account for the other person. For example, a malicious user could attempt to impersonate a person to access the bank account of the person by inputting information into a form for forgotten passwords on a website of the bank.

These forms often have additional security measures or safeguards. For example, some websites and/or applications utilize security questions that a user can select and provide answers to, such that other users are unlikely to know the correct answers to the selected questions. Another safeguard is two-factor authentication (and/or multifactor authentication), which requires a second device or account. More specifically two-factor authentication can require a code sent to an e-mail account associated with the user account, a text message to a mobile device associated with the user account, a call to a device associated with the user account, etc.

However, deployment of these additional security measures and safeguards are often in rigid environments and rely on storing cookies on user devices. Furthermore, these safeguards are unable to be used selectively when there is less confidence in the identity of the user. Thus, these additional security measures often are annoyances to users legitimately signing onto their own accounts. Accordingly, there is in a need in the art for enabling a more efficient and frictionless method for users to access their accounts and services, while maintaining account security.

The present technology addresses the need in the art for more information regarding an identity of a user interacting with a service. More specifically, the present technology receives behavioral and device data to determine an identity of the user. For example, behavioral data can include data (e.g., mouse clicks, keypresses, touch inputs, orientation of the device, etc.) from sensors (e.g., keyboard, mouse, gyroscope, accelerometer, etc.) that exemplify various habits or biometrics of the user while the user interacts with the service (e.g., typing speed, field switching, hesitation percentage, etc.). As another example, device data (e.g., MAC address, IP address, browser type and/or version, operating system, etc.) can be used to identify a device to determine whether this device has previously accessed this service and/or account. A machine learning model can receive the behavioral data and the device data to determine whether the behavioral data matches a biometric fingerprint of the actual user of the account and/or whether the device data matches a device fingerprint that the actual user has previously used.

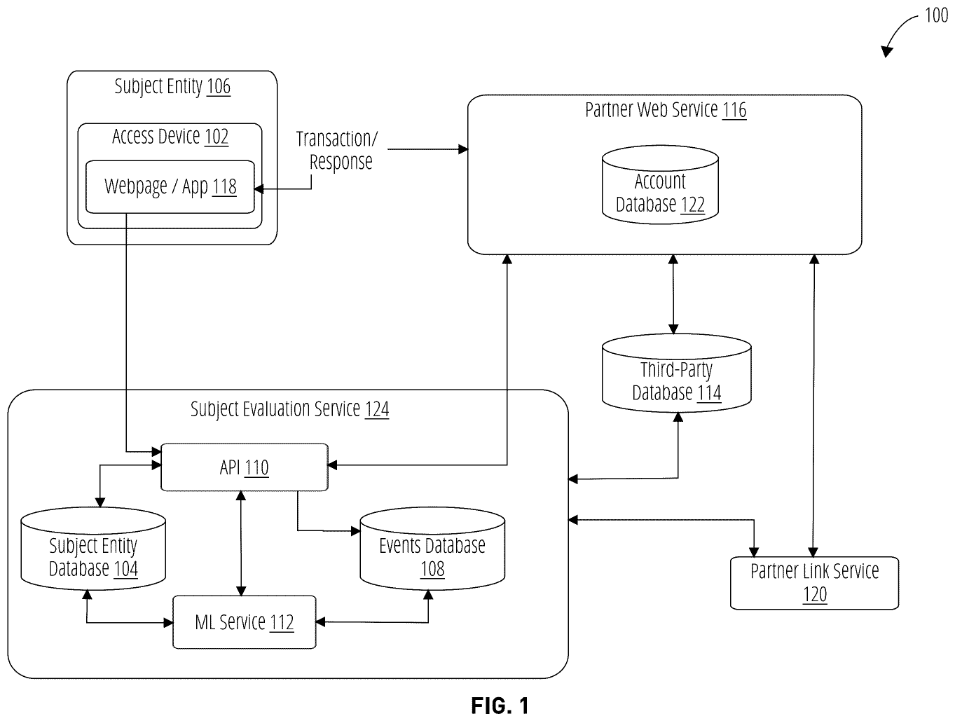

FIG. 1 illustrates an example network environment 100 for utilizing a subject evaluation service 124 to assist a partner web service 116 to evaluate transactions by a subject entity 106 utilizing the partner web service 116.

FIG. 1 illustrates an example network environment 100, in which a subject entity 106 utilizes an access device 102 to access a partner web service 116 associated with a partner web service 116 (e.g., a merchant, provider, payment processor, financial institution, crypto exchange, crypto wallet, etc.). In some embodiments, the partner web service 116 has a webpage/app 118 (application (app) or webpage) loaded and executing on the access device 102. The webpage/app 118 associated with the partner web service 116 can include code to report various events to API 110 of subject evaluation service 124. In some instances, the webpage/app 118 can report the events directly to API 110, and in some cases, the webpage/app 118 can report the events through partner web service 116. As will be described further herein, the events that are reported to API 110 of subject evaluation service 124 are useful in providing additional insight into the transaction regarding the likelihood that the subject entity 106 is a fraudulent party that is attempting to conduct the transaction, or other insight pertaining to the subject entity 106.

Subject entities 106 can include individuals and entities that conduct transactions. More specifically, subject entities 106 can perform or conduct on-chain transactions, off-chain transactions, and traditional transactions. On-chain transactions are transactions that occur on a blockchain that are reflected on a distributed, public ledger. On-chain transactions are typically validated and authenticated and lead to an update to the overall blockchain network. For example, a subject entity 106 may purchase a cryptocurrency on a crypto exchange. Off-chain transactions are transactions that occur outside of a blockchain. For example, a subject entity 106 may purchase a cryptocurrency wallet from another person, such that the value of the cryptocurrency is transferred to the subject entity 106, but the blockchain does not identify the transaction. Traditional transactions are transactions that are unrelated to blockchains, such as a credit card transaction at a merchant, depositing a check, an Automated Cleaning House (ACH) transaction to move money from one account to another, etc. For example, a subject entity 106 may purchase clothing with a credit card or debit card on a third-party website (e.g., a partner web service 116) that is associated with or otherwise connected to network environment 100.

Partner web services 116 are applications, websites, and/or services for entities or platforms (e.g., merchants, service providers, payment processors, financial institutions, crypto exchanges, crypto wallets, etc.) associated with or otherwise connected to network environment 100. For example, merchants typically have a website (e.g., a partner web service 116) that people can purchase goods or access services. As another example, people typically use a website or crypto exchange service to trade cryptocurrency.

Partner web service 116 can be in communication with various databases and services. For example, partner web service 116 can have access to one or more databases maintained by partner web service 116, such as, for example, an account database 122 that stores user profiles and other account information associated with respective subject entities 106. Partner web service 116 can also communicate with and access one or more third-party databases 114 such as credit reporting databases, people search databases, social network databases, etc., to access additional information pertinent to the services provided by partner web service 116.

In some embodiments, network environment 100 can be useful to connect partner web service 116 to subject evaluation service 124 to evaluate the subject entity attempting to conduct a transaction with partner web service 116. Subject evaluation service 124 can perform its functions for many partner web services 116, and as such, it can aggregate information about the subject entity 106 as the subject entity interacts with the partner web services 116 across the Internet. Subject evaluation service 124 can build a profile to identify subject entities using event data that is difficult for those committing fraud to impersonate. Subject evaluation service 124 can utilize transaction information from many partner web service 116 to train one or machine learning algorithms using ML service 112 to evaluate various transaction dimensions to determine whether the subject entity is authentic or is a fraudulent entity impersonating the subject entity.

Subject entity database 104 can store routine personal identifying information such as phone numbers, e-mails, SSNs, bank account numbers, credit card numbers, blockchain wallets, etc., and user behavior information such as typing dynamics, mouse control dynamics, access device identifying information, and more. In other words, subject entity database 104 can include various types of data that can identify and/or be linked to or associated with a particular user (e.g., subject entity 106).

In some embodiments, the subject evaluation service 124 can utilize the ML service 112 to train machine learning algorithms to evaluate other aspects of a transaction beyond whether a fraudulent entity is impersonating the subject entity 106. For example, the subject evaluation service 124 can include ML algorithms that are able to evaluate patterns in a subject entity's service usage to help evaluate transaction risks associated with a particular transaction involving the subject entity.

Application programming interface 110 (API 110) provides an interface between partner web service 116 and subject evaluation service 124 and is configured to receive event data from webpage/app 118. The event data can include a variety of information pertaining to aspects of how the subject entity 106 interacts with the webpage/app 118 (e.g., mouse movements, keyboard events, typing speed, movement of the device, etc.). In some aspects, the event data is pseudo-biometric data because a collection of such data can be used to identify a particular subject entity. API 110 is configured to record various behavioral biometrics. In some embodiments, the device events can be collected and reported by a script or algorithm deployed on webpage/app 118 that communicates directly or indirectly (through partner web service 116) with API 110 of subject evaluation service 124. In some embodiments, webpage/app 118 is further configured to stream the data (for example, while a subject entity 106 is filling out a form), or in a batch (after the subject entity 106 submits the form).

Events database 108 is configured to store the data received by API 110. In some embodiments, events database 108 is further configured to communicate with ML service 112.

API 110 is configured to record biometric data (e.g., mouse movements, keyboard events, typing speed, movement of the device, etc.). In some embodiments, API 110 is called by an algorithm, script, or a software development kit (SDK) deployed on partner web service 116 and executed on or by access device 102. Additionally, API 110 is configured to asynchronously receive biometric behavioral data and/or device intelligence data. Similarly, API 110 is configured to asynchronously provide the biometric data and/or device intelligence data to events database 108. In some embodiments, API 110 is also configured to provide the data to ML service 112.

ML service 112 can be configured to receive data to train an ML model and/or to use a trained ML model to evaluate received data. More specifically, ML service 112 can be configured to receive the behavioral biometric data and/or device intelligence data from events database 108 to train the ML model or to receive data from API 110 to identify a particular user associated with the data using a trained ML model.

Subject entity database 104 can be the same database as events database 108 or separate. Subject entity database 104 can be configured to store information about a subject entity. For example, subject entity database 104 can store statistics regarding the behavioral biometric data and/or device intelligence data that might be used to identify a subject entity and/or the access devices that a subject entity regularly utilizes to access one or more services. Subject entity database 104 can also be configured to store conclusions of a trained ML algorithm pertaining to subject entity, such as a conclusion of the approximate age of the subject entity based on data defining attributes of how the subject entity moves a mouse or their typing speed.

In some embodiments, the subject evaluation service 124 might access one or more third-party database 114 or partner link service 120 to collect additional information to evaluate subject entity 106. One or more third-party databases 114 can include credit reporting databases, people search databases, social network databases, etc. The partner link service 120 can be a service that has access to one or more accounts of the subject entity 106, including accounts at web services other than the partner web service 116. Some partner link services 120 can obtain account access credentials from subject entity 106 to one or more accounts to facilitate the processing of one or more transactions on behalf of subject entity 106.

Collectively network environment 100 provides a system that facilitates a partner web service 116 to utilize evaluations made by the subject evaluation service 124 regarding the subject entity 106 to permit the partner web service 116 to decide whether to proceed with a transaction. Such evaluations might indicate that a fraudulent party is impersonating a subject entity and/or that a subject entity is attempting to perform a transaction that might come with increased risk. The subject evaluation service 124 can make these evaluations because subject evaluation service 124 tracks a subject entity and aggregates data as the subject entity performs transactions with a plurality of web services.

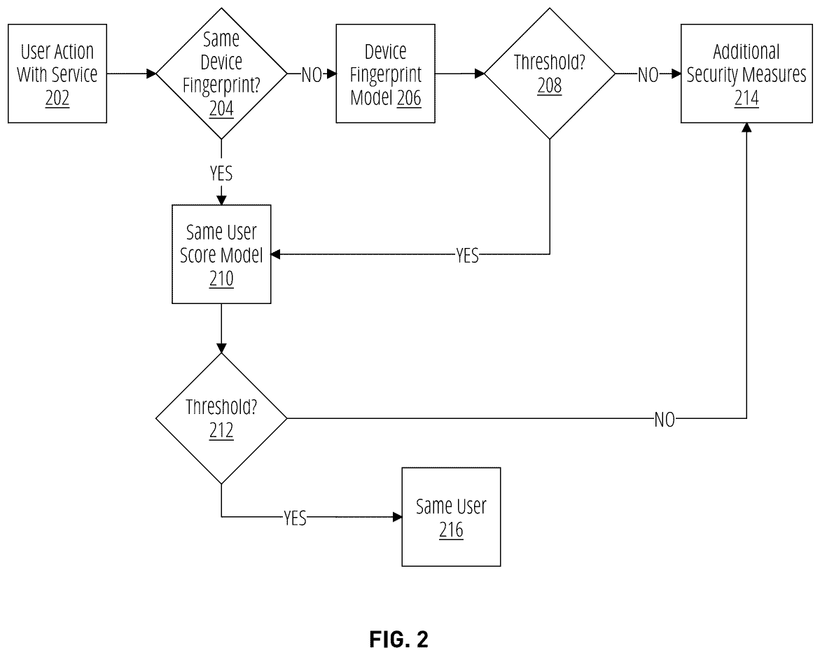

FIG. 2 illustrates an example workflow for ascertaining an identity of an end user and determine whether the identity of the end user is the same as an identity associated with information inputted by the end user. For example, the end user may be inputting personal information to create an online bank account, such that the personal information is information inputted by the end user. In most instances, the end user typically legitimately inputs authentic information. In these instances, the determined identity of the end user is likely to match with the identity associated with the inputted personal information. However, in some instances, the end user may be a malicious or bad actor attempting to impersonate the person that the personal information truly belongs to and/or is associated with. Thus, in these instances, the personal information inputted by the end user would be associated with an identity that is different from the determined identity of the end user.

Although the example workflow depicts a particular sequence of operations, the sequence may be altered without departing from the scope of the present disclosure. For example, some of the operations depicted may be performed in parallel or in a different sequence that does not materially affect the function of the workflow. In other examples, different components of an example device or system that implements the workflow may perform functions at substantially the same time or in a specific sequence.

For clarity and discussion purposes, the following discussion will refer to the person performing the action and/or interaction with the service as the end user. Additionally, the following discussion will refer to the person associated with the inputted information as the claimed person. As discussed above, in some instances the end user may be the claimed person. In other instances, the end user is not the claimed person. In some instances, the end user may not be the claimed person but is legitimately performing the action and/or interaction on behalf of the claimed person (i.e., with the approval of the claimed person).

At step 202, an end user (e.g., subject entity 106) interacts with a service (e.g., partner web service 116) by performing actions on a webpage or application (e.g., webpage/app 118) of the service, such that the webpage or application is executing and/or other accessible or visible on an access device (e.g., access device 102) of the end user. For example, the end user may be logging into a customer account on a merchant website, logging into a personal account on a banking portal, logging into an account on a video streaming service, etc. As another example, the end user may be creating an account with a library, creating a bank account, creating a webpage on a website as an identified author, etc. As yet another example, the end user may be claiming an identity when posting to a website, blog, video channel, social media network, etc. In other words, the end user is performing an action and/or interaction that can be associated with an identity.

At step 204, workflow 200 can determine whether device data of the access device of the end user matches with at least one device fingerprint of a set of device fingerprints associated with the claimed person. Each interaction the claimed person performs with a service can be recorded, such that device data of the claimed person can be recorded. In some embodiments, the device data is provided to the service (e.g., partner web service 116). In some embodiments, the device data is provided to an evaluation service (e.g., to subject evaluation service 124 via API 110). The service and/or evaluation service can be configured to generate a device fingerprint based on device data for each interaction. Each device fingerprint can be added to a set of device fingerprints that is associated with the claimed person. The device data can include data of the access device including, but not limited to, the operating system, the Media Access Control (MAC) address, the Internet Protocol (IP) address), the browser type and version used to access the service, the International Mobile Equipment Identity (IMEI), location data, latitude and longitude coordinates, etc. In some embodiments, the set of device fingerprints can be specific to a type of device. For example, one set of device fingerprints can be for smartphones, mobile devices, and/or tablets, while another set of device fingerprints can be for personal computers, laptops, and/or desktops. Additionally each set of device fingerprints can comprise different types of device data. For example, the set of device fingerprints for mobile devices may include device data identifying the IMEI, operating system, and application version, while the set of device fingerprints for computers may include device data identifying the MAC address, the IP address, the browser type and version used to access the service, and the operating system. The above is a non-exhaustive list of device data that can be used to form one or more device fingerprints and one of ordinary skill in the art would understand that many other types of device data or identifiers can be used to form and/or otherwise add to the device fingerprints.

If the device data does not match with at least one device fingerprint in the set of device fingerprints associated with the claimed person, then device data is input into device fingerprint model 206. Device fingerprint model 206 is configured to receive device data and data inputted by the end user (e.g., personal identifying information, login credentials, names, etc.) and determine, in relation to a threshold, whether the device data is likely to belong the claimed person. For example, the computer of the end user may have updated operating systems and browser versions, while retaining the same MAC address and IP address. Device fingerprint model 206 is configured to determine a same device score that identifies a likelihood that the device is a device that was previously used by the claimed user (e.g., a trusted device). In some embodiments, each type of device data can be given a different weight. More specifically, some types of device data is more fluid, while other types of device data are more static. For example, operating systems, browser versions, and application versions are often more fluid because they can be updated over time. As another example, IMEI and MAC addresses are often unchangeable (e.g., by regulations and/or practically impossible). Thus, the more fluid types of device data can be given a lower weight, while the more static types of device data can be given a higher weight. Furthermore, sets of device fingerprints can be given different weights. For example, one set of device fingerprints can be weighted higher because the user has used the device associated with a subset of the device fingerprints multiple times. In some embodiments, the set of device fingerprints can include an aggregation of multiple device fingerprints, such that a subset of the multiple device fingerprints are associated with a device that has been updated. In other words, the subset of the multiple device fingerprints identify the same device but with some differing types of data (e.g., changes in fluid data, updated operating system, updated browser version, different browser, updated application, etc.). Additionally, device fingerprint model 206 can determine, based on the same device score in relation to a threshold, whether the access device is a device associated with the claimed person.

At step 208, the service and/or evaluation service determines whether the device data of the access device is sufficiently similar to one or more fingerprints of previously used access devices of the claimed user. For example, subject evaluation service 124 can leverage device fingerprint model 206 (e.g., as deployed on ML service 112) to determine, based on the same device score in relation to a threshold, whether the access device is a device associated with the claimed person (e.g., the access device is an access device that the claimed person has previously used with some changes of device data). The threshold can be set based on a degree of trust. For example, a higher threshold would indicate less trust for differences between data and would require the device data to be closer to one or more device fingerprints of access devices previously used by the claimed person. In other words, a higher threshold would require less differences between the device data and one or more device fingerprints of access devices previously used by the claimed person. In some embodiments, the same device score is indicative of a likelihood that the access device belongs to the claimed person, based on past usages of devices by the claimed person.

In some embodiments, the end user may use a password manager and/or autofill capabilities of browsers and/or applications to quickly and/or nearly instantaneously complete the field or form. The machine learning model can identify the inputs and recognize event data indicative of the field or form being filled or completed and determine the usage of the password manager and/or autofill capabilities. The usage of these types of technologies can be indicative that the end user has previously used the device to access the account. In some embodiments, the machine learning model can determine, based on the usage of these types of technology as positive signals that reinforce the probability that the end user has previously used the device to access the account.

If it is determined that the device data of the access device is sufficiently similar to one or more device fingerprints of previously used access devices of the claimed user, then the service and/or evaluation service can input behavioral data into same user score model 210.

Similarly, if at step 204 the service and/or evaluation service determines that the device data matches one or more device fingerprints associated with the claimed user, then the service and/or evaluation service can input behavioral data into same user score model 210.

Same user score model 210 is configured to receive event data recorded by one or more sensors of the access device of the end user and data inputted by the end user (e.g., personal identifying information, login credentials, names, etc.) and generate a same user score. Same user score model 210 can generate a same user score based on the event data, derivations of behavioral and habitual patterns therefrom, and the one or more biometric fingerprints of the claimed person.

The event data is also referred to herein as biometric data and/or behavioral data. Event data can include a variety of information pertaining to aspects of how the subject entity 106 interacts with the webpage/app 118. For example, event data can include, but is not limited to, x-y coordinates of a cursor, mouse movements, mouse clicks, mouse wheel scrolls, mousepad inputs, keyboard events, key inputs, keystrokes, keypress down, keypress releases, movement of the device, etc. The same user score is a score that is indicative of a likelihood that the end user is the claimed person. Same user score model 210 and/or subject evaluation service 124 can determine, based on the same user score in relation to a threshold, whether the event data is sufficiently similar to one or more biometric fingerprints of the claimed person. More specifically, the one or more biometric fingerprints are aggregations of behavioral biometrics or pseudo behavioral biometrics of the claimed person that are derived from event data recorded while the claimed person previously interacted with one or more services. Additionally, the one or more biometric fingerprints can be specific to a particular type of device. For example, one biometric fingerprint can be used for mobile devices, while another biometric fingerprint can be used for computers with a keyboard, mouse, mousepad, and/or touch screen.

Same user score model 210 can derive behavioral biometrics or pseudo behavioral biometrics from the event data. For example, same user score model 210 can derive a manner or habit of switching from one field to another field (e.g., by pressing the “tab” key, by clicking into the next field, by utilizing a combination of pressing the “tab” key and clicking the next field, etc.).

As another example, same user score model 210 can derive a velocity and precision of mouse movements (e.g., by analyzing x-y coordinates of a cursor over time). In some embodiments, the velocity and precision of mouse movements can identify jitters, hesitation, or shakiness. For example, some users have better hand-eye coordination, which results in quicker and more precise mouse movements, while other users may have slower and shakier mouse movements. Similarly, some users prefer scrolling using different methods such as using a scroll wheel of a mouse, using two-finger scroll gestures on a mouse pad, using a pointing stick or trackpoint on a laptop, etc.

As yet another example, same user score model 210 can derive an amount of time spent filling out the one or more fields of a form or other input habits including, but not limited to, frequency of typographical errors, usage of copy and paste controls, usage of input support software (e.g., sticky keys, filter keys, etc.).

Additionally, same user score model 210 can derive typing speed and/or method of typing (e.g., using all ten fingers, using two fingers, individual touch inputs for typing, continuous or “gesture” touch inputs for typing, etc.). For example, some users type with one finger on each hand, while other users type with all ten fingers resulting in faster typing and minimal or no time lag between key inputs and/or keypress and releases. As another example, some users gravitate towards a particular method of touchscreen typing (e.g., gesture typing, individual touch inputs, etc.).

It is further considered that each type of event data can be given a different weight. For example, some types of data may have more variance than other types of data. In other words, some types of event data can be consistent across users (e.g., less variance), while other types of event data fluctuate comparatively more. Same user score model 210 can adjust weights for each type of data to improve scoring. For example, same user score model 210 may determine over time (e.g., by receiving feedback data that identifies whether the end user was actually the claimed person) that patterns of mouse movements are less consistent in providing accurate predictions that the end user is the claimed person.

Additionally, same user score model 210 and/or subject evaluation service 124 can aggregate the event data across various different partner web services 116 that the claimed person has interacted with. Same user score model 210 and/or subject evaluation service 124 can utilize the aggregated event data from multiple partner web service 116 to generate one or more biometric fingerprints, such that each biometric fingerprint can include event data from one or more partner web services 116.

At step 212, same user score model 210 and/or subject evaluation service 124 can determine whether the end user is actually the claimed person based on the same user score in relation to a threshold. In some embodiments, the workflow can additionally or alternatively perform cosine similarity between historical event data of the claimed person and the event data recorded while the end user is performing an action and/or interaction with the service. For example, if the same user score is above the threshold, then it is highly probable that the end user is actually the claimed person. Accordingly, same user score model 210 and/or subject evaluation service 124 can determine that the end user is indeed the claimed person, based on the same user score exceeding the threshold.

If same user score model 210 and/or subject evaluation service 124 determines, based on the same user score in relation to threshold, that the same user score is insufficient to determine that the end user is actually the claimed user, then the end user is prompted to perform additional security measures at step 214. For example, the end user may be required (e.g., by partner web service 116) to answer security questions. As another example, the end user may be required to perform multifactor authentication with a device that is already associated with the account of the claimed person.

If same user score model 210 and/or subject evaluation service 124 determines, based on the same user score in relation to the threshold, that the same user score is sufficient to determine that the end user is actually the claimed user, then the same user score model 210 and/or subject evaluation service 124 determines that the end user is indeed the claimed person at step 216.

In some embodiments, same user score model 210 and/or subject evaluation service 124 can provide the determination that the end user is the claimed person to partner web service 116. Partner web service 116 can then granted access to the end user to complete the action and/or interaction that the end user was performing at step 216.

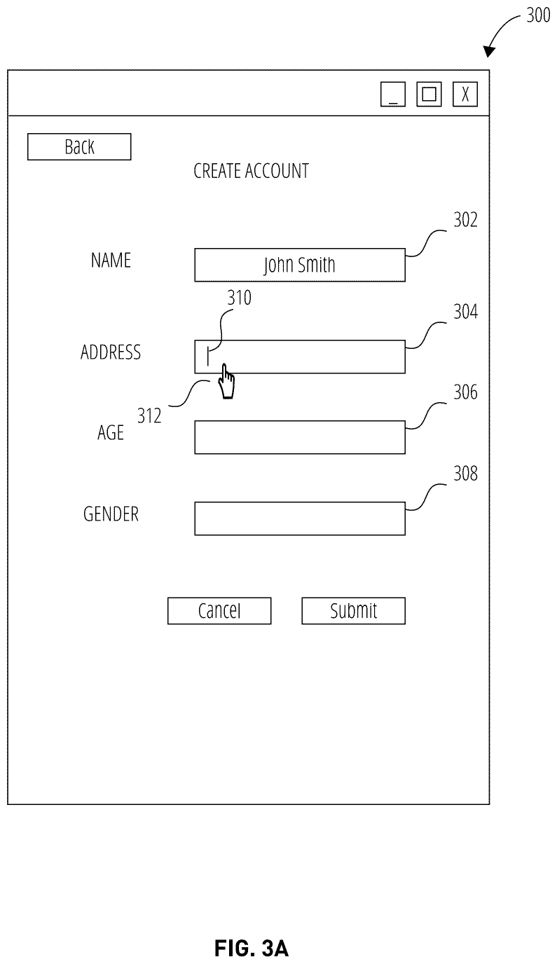

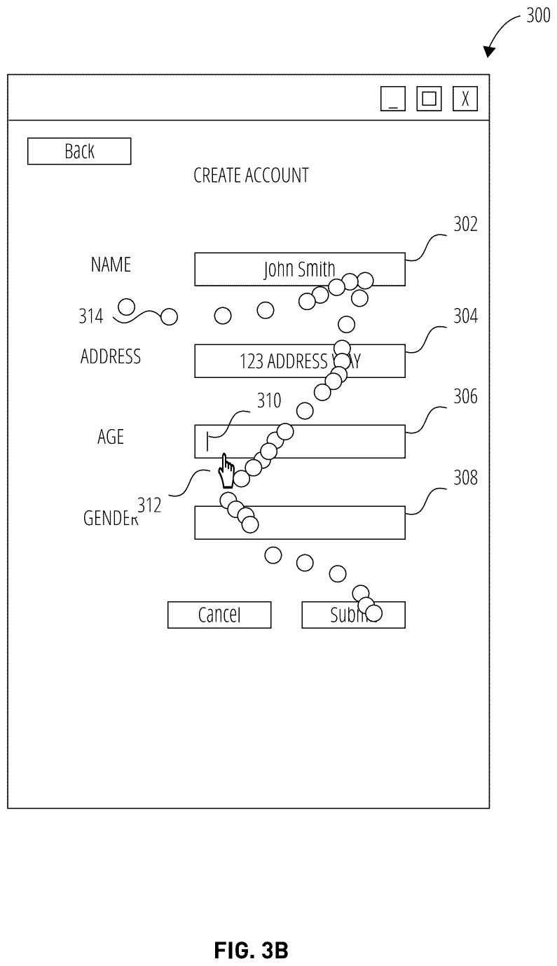

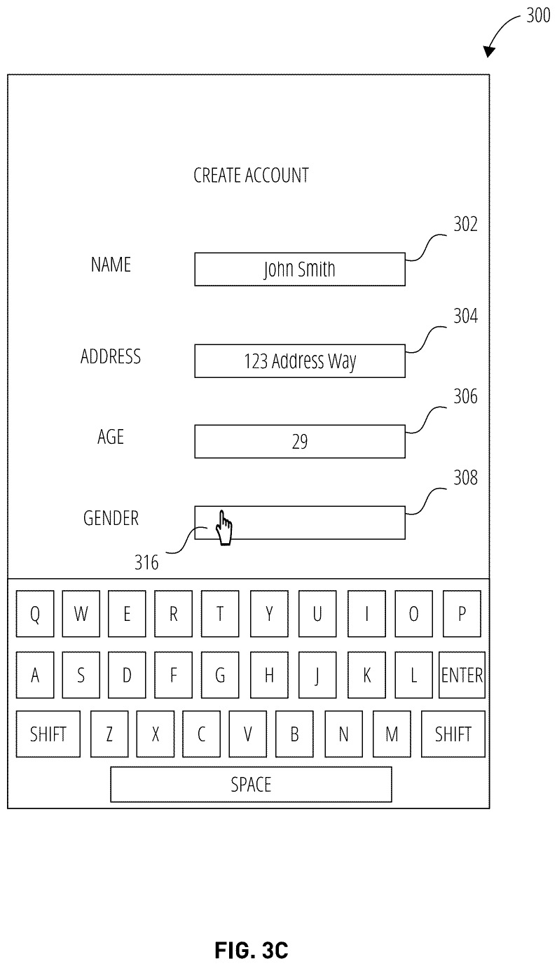

FIG. 3A and FIG. 3B illustrate a webpage embodiment of webpage/app 300. For example, webpage/app 300 may be webpage/app 118 of partner web service 116. More specifically, a computer or other access device (e.g., access device 102) can run or otherwise display webpage/app 300 with a graphical user interface (GUI) on a display associated with the access device.

Webpage/app 300 may have one or more fields 302, 304, 306, 308 that require input from a user (e.g., subject entity 106). On computers and other access devices (e.g., access device 102), the GUI may include a text cursor 310 and a cursor 312. A text cursor 310 is a position indicator on the display where a user can enter text. Cursor 312 is a visible and moving pointer that the user controls with a mouse, touch pad, or similar input device. As a user fills out fields 302, 304, 306, 308, the user will utilize input devices, such as a keyboard, a mouse, a keypad, etc. For example, the user will type answers into fields 302, 304, 306, 308 using a keyboard and/or keypad. Additionally, as the user completes an answer in one field (e.g., field 302), the user will switch to another field (e.g., field 304) by either pressing “tab” on the keyboard and/or moving the mouse to align cursor 312 over field 304 and click the mouse.

As discussed above, webpage/app 300 can include code, scripts, algorithms, and/or a SDK deployed thereon. The code is configured to record event data as the user utilizes the access device to interact with a GUI of webpage/app 300. Event data can include a variety of information pertaining to aspects of how the subject entity 106 interacts with the webpage/app 300. For example, event data can include, but is not limited to, x-y coordinates of cursor 312, mouse movements, mouse clicks, mouse wheel scrolls, mousepad inputs, keyboard events, key inputs, keystrokes, keypress down, keypress releases, movement of the device, etc. The event data is also referred to herein as biometric data and/or behavioral data. The event data is a collection of such data that can be used to generate a biometric fingerprint of the subject entity accessing webpage/app 300 of partner web service 116.

For example, FIG. 3A illustrates a user that has typed an answer into field 302 using the keyboard. The code on webpage/app 300 records each individual keypress down on the keyboard with timestamps and each individual keypress release on the keyboard with timestamps. For example, FIG. 3A illustrates that the user typed or is typing “John Smith” in field 302. Thus, the code records a timestamp and a keypress down event on the shift button and the letter “J” along with another timestamp and a keypress release event of the shift button and the letter “J.” The code continues to record these events for each keyboard event with respective timestamps.

FIG. 3B illustrates the user has finished typing the answer in field 304 and moves the cursor 312 to field 306. More specifically, the user moves cursor 312 from field 304 to field 306 by moving the mouse. The code on webpage/app 300 can record x-y coordinates of the cursor 312 in relation to the page along with timestamps. In some embodiments, the code can record movements of cursor 312. Thus, the code records a set of x-y coordinates of the cursor 312 at field 304 and a respective timestamp, another set of x-y coordinates of the cursor 312 when the cursor 312 is moved over to field 306 and the respective timestamp, and a mouse click event or clicking of the mouse when the cursor 312 is over field 306 to select field 306 for text input. The code on webpage/app 300 then continues to record the typing event data associated with inputting text into field 306 (e.g., keypress down, keypress release, timestamps, etc.).

For example, FIG. 3B illustrates a mouse trail 314 over webpage/app 300. In some embodiments, the mouse trail 314 may not be visible to the user, but the data of mouse trail 314 can still be recorded despite not being displayed to the user. Mouse trail 314 is a set of coordinates associated with a timestamp. For example, each dot in mouse trail 314 can represent a timestamp and x-y coordinate of where the cursor 312 is on the display at a particular time. In other words, each dot illustrates an example measurement or packet of data that captures some event (e.g., movement of the mouse). Thus, as these timestamps and x-y coordinates are aggregated, they form mouse trail 314.

In some embodiments, webpage/app 300 can directly send the points and timestamps of mouse trail 314 directly to ML service 112. In some embodiments, webpage/app 300 can process the data (e.g., timestamps and x-y coordinates) into refined information, such as velocity, jitter, hesitation percentage, and other behavioral biometrics, and send the processed or refined information to the subject evaluation service 124 and/or ML service 112.

As discussed above, webpage/app 300 can include code to report various events to an API (e.g., API 110 of subject evaluation service 124). In some instances, the webpage/app 300 can report the events directly to the API, and in some cases, the webpage/app 300 can report the events through the service associated with webpage/app 300 (e.g., partner web service 116). In some embodiments, the code can asynchronously send the recorded data to a database (e.g., events database 108) and/or a machine learning model (e.g., a machine learning model deployed on ML service 112).

FIG. 3C illustrates an application embodiment of webpage/app 300. For example, webpage/app 300 may be webpage/app 118 of partner web service 116. More specifically, an access device (e.g., access device 102) of the user can include a touchscreen device including, but not limited to, a smartphone, a tablet, a laptop, a touchscreen computer, a mobile device, and other touchscreen devices. The access device can run or otherwise display webpage/app 300 with a GUI on a touchscreen display of the access device.

Webpage/app 300 may have one or more fields 302, 304, 306, 308 that require input from a user (e.g., subject entity 106). The touchscreen display of the access device is configured to receive touch inputs 316 when the user touches the device. For example, FIG. 3C illustrates that the user has typed answers in fields 302, 304, and 306. FIG. 3C further illustrates a touch input 316 at field 308. In other words, the user has tapped the area of the display where the GUI displays field 308. Webpage/app 300 is configured to record the touch input 316, the location of the touch input 316, and a timestamp for the touch input 316.

In some embodiments, the access device is a mobile device that includes other sensors and webpage/app 300 is configured to record and/or receive sensor data from sensors of the mobile device. For example, modern smartphones now have accelerometers and gyroscopes that are configured to record sensor data that is indicative of motion and tilt of the smartphone. More specifically, gyroscopes are configured to measure tilt or rotation around one or more spatial axes. Accelerometers are configured to measure acceleration or change in velocity of the mobile device. Accordingly, webpage/app 300 (e.g., via the code running thereon) is configured to record measurements of rotation and changes in velocity of the mobile device. For example, some users may prefer to hold the phone lower and angle the phone at approximately a 45 degree angle respective to the ground. Other users may prefer to hold the phone higher and angle the phone near perpendicular to the ground at eye level. The gyroscope of the mobile device can identify the rotational orientation and store the orientation and/or the changes relative to a frame of reference as sensor data. Webpage/app 300 (e.g., via the code deployed thereon) can record the sensor data from the gyroscope and provide the data to an evaluation service (e.g., subject evaluation service 124 via API 110) and/or a machine learning model (e.g., as deployed on ML service 112). As another example, some users of mobile devices are able to type more quickly while keeping the mobile device more stable. On the other hand, some users of mobile devices may type slower and have shakier hands. The accelerometer can measure the movement as the users tap the mobile device to type and the jitters of the users and store the measurements as sensor data. As discussed above, webpage/app 300 (e.g., via the code executing on the mobile device) can record the sensor data from the accelerometer and provide the data to an evaluation service (e.g., subject evaluation service 124 via API 110) and/or a machine learning model (e.g., as deployed on ML service 112).

The machine learning model (e.g., as deployed on ML service 112) is configured to receive event data of a user from a user device while the user interacts (e.g., fills out a form, presses through pages, etc.) with a GUI to access a service (e.g., webpage/app 300, webpage/app 118, partner web service 116, etc.). The machine learning model is configured to generate a same user score that identifies a likelihood that the user associated with the event data is the claimed person based on the received or inputted event data. In some embodiments, the machine learning model can derive behavioral biometrics or pseudo behavioral biometrics from the event data. As discussed above, the event data can include timestamps, movements of a mouse, clicking of the mouse, scrolling of a scroll wheel of the mouse, mousepad inputs, x-y coordinates of a cursor associated with the mouse, a key input on a keyboard, a key stroke, a keypress down of a key on the keyboard, a keypress release of the key on the keyboard, field switching, time spent on a web page, orientation of a mobile device, usage of a shortcut, etc.

The machine learning model can, for example, derive a manner or habit of switching from one field to another field (e.g., by pressing the “tab” key, by clicking into the next field, by utilizing a combination of pressing the “tab” key and clicking the next field, etc.).

As another example, the machine learning model can derive a velocity and precision of mouse movements (e.g., by analyzing x-y coordinates of cursor 312 over time). In some embodiments, the velocity and precision of mouse movements can identify jitters, hesitation, or shakiness. For example, younger users tend to have better hand-eye coordination, which results in quicker and more precise mouse movements. On the other hand, older users tend to have slower and shakier mouse movements.

As yet another example, the machine learning model can derive an amount of time spent filling out the one or more fields of a form or other input habits including, but not limited to, frequency of typographical errors, usage of copy and paste controls, usage of input support software (e.g., sticky keys, filter keys, etc.).

Additionally, the machine learning model can derive typing speed and/or method of typing (e.g., using all ten fingers, using two fingers, individual touch input 316 for typing, continuous or “gesture” touch input 316 for typing, etc.). For example, some users may type with one finger on each hand, while other users may type with all ten fingers, which results in faster typing and minimal or no time lag between key inputs and/or keypress and releases. As another example, some users may gravitate towards a particular method of touchscreen typing (e.g., gesture typing, individual touch inputs, etc.).

The machine learning model can predict, based on the event data and the derivations of behavioral and habitual patterns therefrom, a same user score. More specifically, the machine learning model generates, based on the event data obtained from the user device as the user interacted with the GUI of the service, a same user score. The machine learning model can then determine, based on the same user score in relation to a threshold, that the end user is the claimed person.

In some embodiments, the code is deployed on webpage/apps 300 of multiple different partner web services 116. Each webpage/app 300 can send event data along with other identifying data (e.g., an account stored in account database 122 of partner web service 116). For example, the user may utilize multiple different social media networks. Accordingly, each social media network can have a webpage/app 300 that includes code to record event data from the user device as the user interacts with the webpage/app 300. The machine learning model can receive the event data for the user from all of the webpage/apps 300 (e.g., additional event data) and further refine derivations and predictions based on the additional event data.

In some embodiments, the machine learning model can determine whether a current interaction is fraudulent based on the additional event data. In some embodiments, the machine learning model can determine behavioral or habitual patterns of the user. For example, the machine learning model can identify that an average typing speed of the user is approximately 40 words per minute, a habit of utilizing the keyboard rather than the mouse to navigate the webpage (e.g., by pressing “tab,” “shift” and “tab,” “enter,” etc.). The machine learning model can compare the event data from the current interaction against the additional event data and the patterns derive therefrom. If the event data is significantly different from the identified behavioral patterns, then the machine learning model can determine that the current interaction is likely fraudulent and/or performed by a different person from the claimed user.

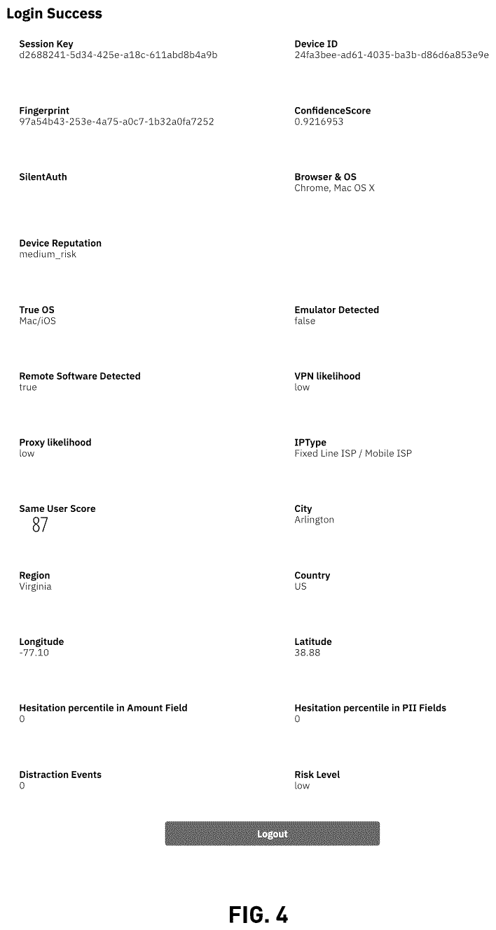

FIG. 4 illustrates an example output that subject evaluation service 124 and/or same user score model 210 can generate. As illustrated in FIG. 4, various different types of information can be provided (e.g., to partner web services 116). Some of these types of information are recorded device data, such as Device ID, browser and operating system, true operating system, whether there is usage or detection of an emulator, whether there is usage or detection of remote software, a probability of virtual private network (VPN) usage, a probability of proxy usage, location information, etc.

Other types of information can be processed information. For example, the processed information can include a same user score (e.g., based on derived behavioral biometrics and a biometric fingerprint of the claimed person as discussed above), a session key generated by API 110, subject evaluation service 124, and/or partner web service 116 when the end user performs the action and/or interaction with partner web service 116, a confidence score for the provided information, an overall determined risk score or level that is indicative of a relative amount of risk that the action and/or interaction is fraudulent or legitimate, a device reputation for the device based on data aggregated by subject evaluation service 124 across actions and/or interactions by the device with partner web services 116, hesitation percentages or percentiles (e.g., an amount of time that the end user hesitated in a particular page, form, and/or field), etc.

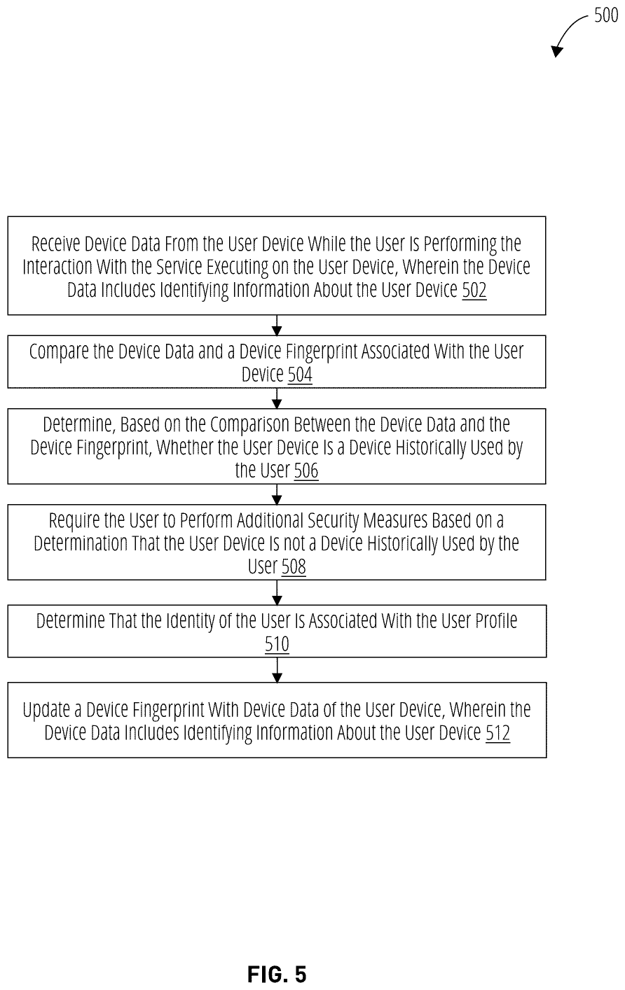

FIG. 5 illustrates an example method 500 for determining whether a device that an end user is using to perform an interaction with a service is associated with a claimed person having a user profile. Although the example method 500 depicts a particular sequence of operations, the sequence may be altered without departing from the scope of the present disclosure. For example, some of the operations depicted may be performed in parallel or in a different sequence that does not materially affect the function of the method 500. In other examples, different components of an example device or system that implements the method 500 may perform functions at substantially the same time or in a specific sequence.

At step 502, method 500 includes receiving device data from the user device while the user is performing the interaction with the service executing on the user device, wherein the device data includes identifying information about the user device. For example, subject evaluation service 124 and/or device fingerprint model 206 can receive device data from the user device while the user is performing the interaction with the service executing on the user device, wherein the device data includes identifying information about the user device.

At step 504, method 500 includes comparing the device data and a device fingerprint associated with the user device. For example, subject evaluation service 124 and/or device fingerprint model 206 can compare the device data and a device fingerprint associated with the user device.

At step 506, method 500 includes determining, based on the comparison between the device data and the device fingerprint, whether the user device is a device historically used by the user. For example, subject evaluation service 124 and/or device fingerprint model 206 can determine, based on the comparison between the device data and the device fingerprint, whether the user device is a device historically used by the user.

At step 508, method 500 includes requiring the user to perform additional security measures based on a determination that the user device is not a device historically used by the user. For example, subject evaluation service 124 and/or device fingerprint model 206 can require the user to perform additional security measures based on a determination that the user device is not a device historically used by the user. As another example, subject evaluation service 124 and/or device fingerprint model 206 can provide the determination to partner web service 116, which can require the user to perform additional security measures based on the determination that the user device is not a device historically used by the user.

At step 510, method 500 includes determining that the identity of the user is associated with the user profile. For example, subject evaluation service 124 and/or device fingerprint model 206 can determine that the identity of the user is associated with the user profile.

At step 512, method 500 includes updating a device fingerprint with device data of the user device, wherein the device data includes identifying information about the user device. For example, ML service 112, subject evaluation service 124 and/or device fingerprint model 206 can update a device fingerprint with device data of the user device, wherein the device data includes identifying information about the user device.

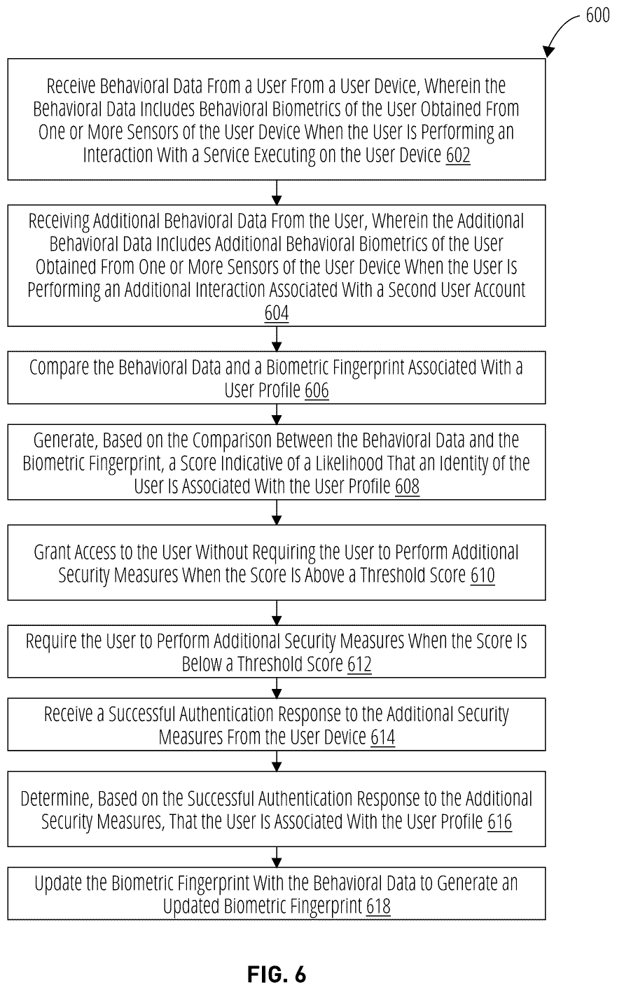

FIG. 6 illustrates an example method 600 for determining whether an end user performing an interaction with a service is actually a claimed person associated with a user profile. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

At step 602, method 600 includes receiving behavioral data from a user from a user device, wherein the behavioral data includes behavioral biometrics of the user obtained from one or more sensors of the user device when the user is performing an interaction with a service executing on the user device. For example, subject evaluation service 124 and/or same user score model 210 can receive behavioral data from a user from a user device, wherein the behavioral data includes behavioral biometrics of the user obtained from one or more sensors of the user device when the user is performing an interaction with a service executing on the user device. In some embodiments, the user device may be a new device that the user has not used to interact with the service before. In some embodiments the interaction may be associated with a first user account.

At step 604, method 600 includes receiving additional behavioral data from the user, wherein the additional behavioral data includes additional behavioral biometrics of the user obtained from one or more sensors of the user device when the user is performing an additional interaction associated with a second user account. For example, subject evaluation service 124 and/or same user score model 210 can receive additional behavioral data from the user, wherein the additional behavioral data includes additional behavioral biometrics of the user obtained from one or more sensors of the user device when the user is performing an additional interaction associated with a second user account. In some embodiments, the biometric fingerprint is based on additional behavioral data from the user. The additional behavioral data can include additional behavioral biometrics of the user obtained from the one or more sensors of the user device when the user is performing an additional interaction with another service.

At step 606, method 600 includes comparing the behavioral data and a biometric fingerprint associated with a user profile. For example, subject evaluation service 124 and/or same user score model 210 can compare the behavioral data and a biometric fingerprint associated with a user profile.

At step 608, method 600 includes generating, based on the comparison between the behavioral data and the biometric fingerprint, a score indicative of a likelihood that an identity of the user is associated with the user profile. For example, subject evaluation service 124 and/or same user score model 210 can generate, based on the comparison between the behavioral data and the biometric fingerprint, a score indicative of a likelihood that an identity of the user is associated with the user profile.

In some embodiments, at step 610, method 600 includes granting access to the user without requiring the user to perform additional security measures when the score is above a threshold score. For example, subject evaluation service 124 and/or same user score model 210 can grant access to the user without requiring the user to perform additional security measures when the score is above a threshold score.

In some embodiments, at step 612, method 600 includes requiring the user to perform additional security measures when the score is below a threshold score. For example, subject evaluation service 124 and/or same user score model 210 can require the user to perform additional security measures when the score is below a threshold score. As another example, subject evaluation service 124 and/or same user score model 210 can provide the score to a partner web service 116, which can require the user to perform additional security measures when the score is below a threshold score.

At step 614, method 600 includes receiving a successful authentication response to the additional security measures from the user device. For example, subject evaluation service 124 and/or same user score model 210 can receive a successful authentication response to the additional security measures from the user device.

At step 616, method 600 includes determining, based on the successful authentication response to the additional security measures, that the user is associated with the user profile. For example, subject evaluation service 124 and/or same user score model 210 can determine, based on the successful authentication response to the additional security measures, that the user is associated with the user profile.

At step 618, method 600 includes updating the biometric fingerprint with the behavioral data to generate an updated biometric fingerprint. For example, ML service 112, subject evaluation service 124 and/or same user score model 210 can update the biometric fingerprint with the behavioral data to generate an updated biometric fingerprint.

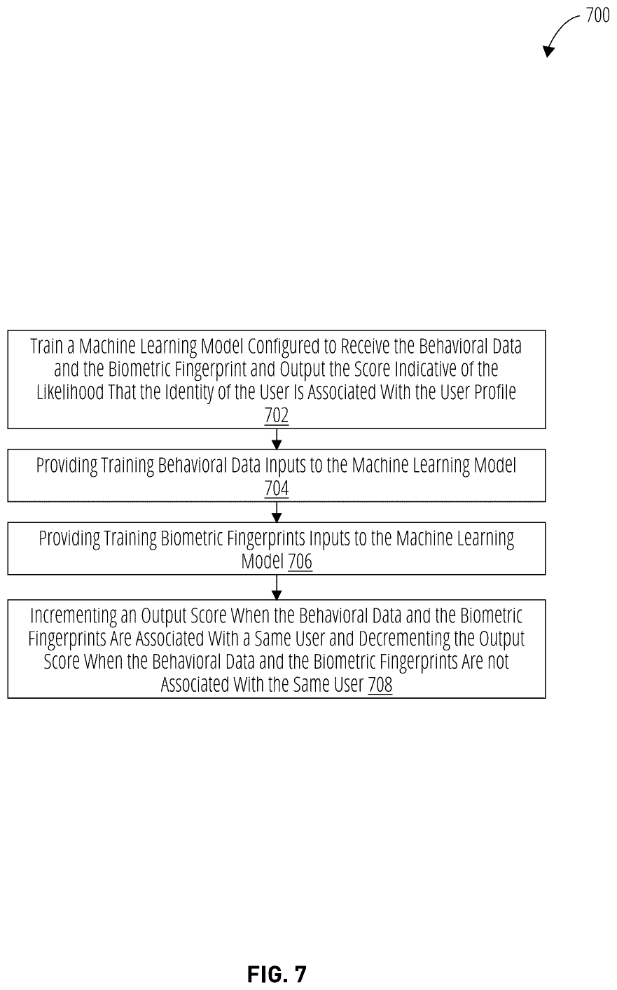

FIG. 7 illustrates an example method 700 for training a machine learning model to determine, based on behavioral data inputs and a biometric fingerprint and/or a user profile having a biometric fingerprint associated thereto, whether the behavioral data inputs are inputted by the user of the user profile associated with the biometric fingerprint. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence.

At step 702, method 700 includes training a machine learning model configured to receive the behavioral data and the biometric fingerprint and output the score indicative of the likelihood that the identity of the user is associated with the user profile. For example, ML service 112 and/or subject evaluation service 124 can train a machine learning model configured to receive the behavioral data and the biometric fingerprint and output the score indicative of the likelihood that the identity of the user is associated with the user profile.

At step 704, method 700 includes providing training behavioral data inputs to the machine learning model. For example, ML service 112 and/or subject evaluation service 124 can provide training behavioral data inputs to the machine learning model.

At step 706, method 700 includes providing training biometric fingerprints inputs to the machine learning model. For example, ML service 112 and/or subject evaluation service 124 can provide training biometric fingerprints inputs to the machine learning model.

At step 708, method 700 includes incrementing an output score when the behavioral data and the biometric fingerprints are associated with a same user and decrementing the output score when the behavioral data and the biometric fingerprints are not associated with the same user. For example, ML service 112 and/or subject evaluation service 124 can increment an output score when the behavioral data and the biometric fingerprints are associated with a same user and decrement the output score when the behavioral data and the biometric fingerprints are not associated with the same user

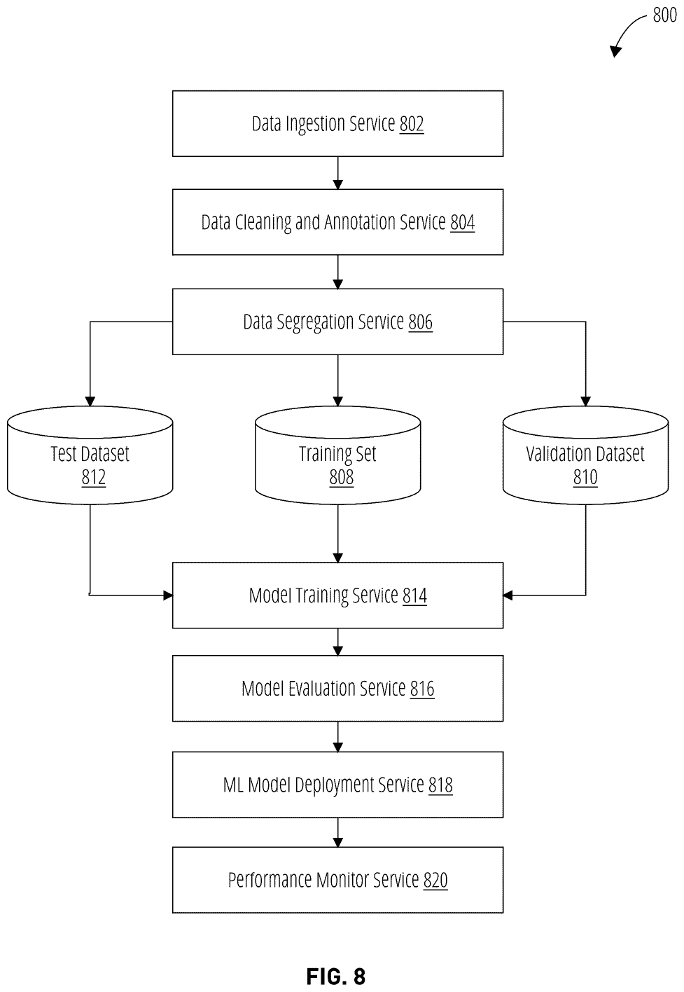

FIG. 8 illustrates an example lifecycle 800 of a ML model in accordance with some examples. The first stage of the lifecycle 800 of a ML model is a data ingestion service 802 to generate datasets described below. ML models require a significant amount of data for the various processes described in FIG. 8 and the data persisted without undertaking any transformation to have an immutable record of the original dataset. The data can be provided from third party sources such as publicly available dedicated datasets. The data ingestion service 802 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 802 retrieves the data. In some examples, the data ingestion service 802 may be online and the data is streamed from the producer in real-time for storage in the data ingestion service 802.

After data ingestion service 802, a data preprocessing service preprocesses the data to prepare the data for use in the lifecycle 800 and includes at least data cleaning, data transformation, and data selection operations. The data cleaning and annotation service 804 removes irrelevant data (data cleaning) and general preprocessing to transform the data into a usable form. The data cleaning and annotation service 804 includes labelling of features relevant to the ML model. In some examples, the data cleaning and annotation service 804 may be a semi-supervised process performed by a ML to clean and annotate data that is complemented with manual operations such as labeling of error scenarios, identification of untrained features, etc.

After the data cleaning and annotation service 804, data segregation service 806 to separate data into at least a training set 808, a validation dataset 810, and a test dataset 812. Each of the training set 808, a validation dataset 810, and a test dataset 812 are distinct and do not include any common data to ensure that evaluation of the ML model is isolated from the training of the ML model.

The training set 808 is provided to a model training service 814 that uses a supervisor to perform the training, or the initial fitting of parameters (e.g., weights of connections between neurons in artificial neural networks) of the ML model. The model training service 814 trains the ML model based a gradient descent or stochastic gradient descent to fit the ML model based on an input vector (or scalar) and a corresponding output vector (or scalar).

After training, the ML model is evaluated at a model evaluation service 816 using data from the validation dataset 810 and different evaluators to tune the hyperparameters of the ML model. The predictive performance of the ML model is evaluated based on predictions on the validation dataset 810 and iteratively tunes the hyperparameters based on the different evaluators until a best fit for the ML model is identified. After the best fit is identified, the test dataset 812, or holdout data set, is used as a final check to perform an unbiased measurement on the performance of the final ML model by the model evaluation service 816. In some cases, the final dataset that is used for the final unbiased measurement can be referred to as the validation dataset and the dataset used for hyperparameter tuning can be referred to as the test dataset.

After the ML model has been evaluated by the model evaluation service 816, an ML model deployment service 818 can deploy the ML model into an application or a suitable device. The deployment can be into a further test environment such as a simulation environment, or into another controlled environment to further test the ML model.

After deployment by the ML model deployment service 818, a performance monitor service 820 monitors for performance of the ML model. In some cases, the performance monitor service 820 can also record additional transaction data that can be ingested via the data ingestion service 802 to provide further data, additional scenarios, and further enhance the training of ML models.

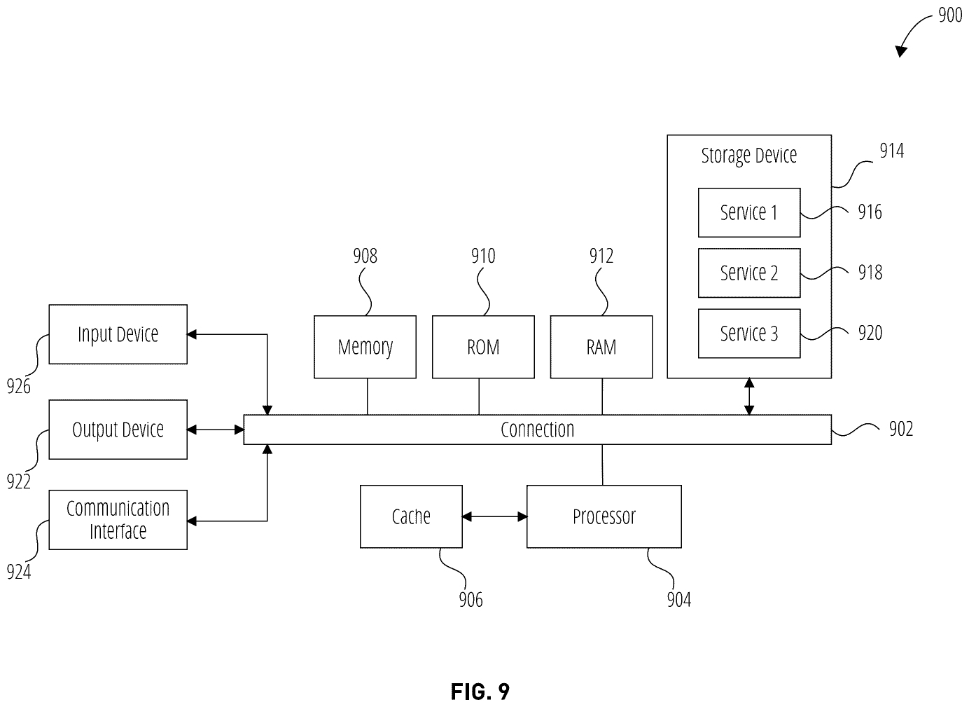

FIG. 9 shows an example of computing system 900, which can be for example any computing device making up access device 102, partner web service 116, partner link service 120, subject evaluation service 124, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 910 and random access memory (RAM) 912 to processor 904. Computing system 900 can include a cache of high-speed memory 906 connected directly with, in close proximity to, or integrated as part of processor 904.

Processor 904 can include any general purpose processor and a hardware service or software service, such as services 916, 918, and 920 stored in storage device 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Example aspects descriptive of the present technology include:

Aspect 1. A computer-implemented method comprising: receiving behavioral data from a user from a user device, wherein the behavioral data includes behavioral biometrics of the user obtained from one or more sensors of the user device when the user is performing an interaction with a service executing on the user device; comparing the behavioral data and a biometric fingerprint associated with a user profile; and generating, based on the comparison between the behavioral data and the biometric fingerprint, a score indicative of a likelihood that an identity of the user is associated with the user profile.

Aspect 2. The computer-implemented method of aspect 1, further comprising: requiring the user to perform additional security measures when the score is below a threshold score.

Aspect 3. The computer-implemented method of any of aspects 1 or 2, further comprising: receiving a successful authentication response to the additional security measures from the user device; determining, based on the successful authentication response to the additional security measures, that the user is associated with the user profile; and updating the biometric fingerprint with the behavioral data to generate an updated biometric fingerprint.

Aspect 4. The computer-implemented method of any of aspects 1-3, wherein the biometric fingerprint is based on additional behavioral data from the user, wherein the additional behavioral data includes additional behavioral biometrics of the user obtained from the one or more sensors of the user device when the user is performing an additional interaction with another service.

Aspect 5. The computer-implemented method of any of aspects 1-4, wherein the user device is a new device that the user has not used to interact with the service before, the method further comprising: determining that the identity of the user is associated with the user profile; and updating a device fingerprint with device data of the user device, wherein the device data includes identifying information about the user device.

Aspect 6. The computer-implemented method of any of aspects 1-5, further comprising: granting access to the user without requiring the user to perform additional security measures when the score is above a threshold score.

Aspect 7. The computer-implemented method of any of aspects 1-6, wherein the interaction is associated with a first user account, the method further comprising: receiving additional behavioral data from the user, wherein the additional behavioral data includes additional behavioral biometrics of the user obtained from one or more sensors of the user device when the user is performing an additional interaction associated with a second user account; and determining, based on the additional biometric data and the biometric fingerprint, that the user is associated with both the first user account and the second user account.

Aspect 8. The computer-implemented method of any of aspects 1-7, further comprising: receiving device data from the user device while the user is performing the interaction with the service executing on the user device, wherein the device data includes identifying information about the user device; comparing the device data and a device fingerprint associated with the user device; and determining, based on the comparison between the device data and the device fingerprint, whether the user device is a device historically used by the user.

Aspect 9. The computer-implemented method of any of aspects 1-8, further comprising: requiring the user to perform additional security measures based on a determination that the user device is not a device historically used by the user.

Aspect 10. The computer-implemented method of any of aspects 1-9, further comprising: training a machine learning model configured to receive the behavioral data and the biometric fingerprint and output the score indicative of the likelihood that the identity of the user is associated with the user profile, the training comprising: providing training behavioral data inputs to the machine learning model; providing training biometric fingerprints; and incrementing an output score when the behavioral data and the biometric fingerprints are associated with a same user and decrementing the output score when the behavioral data and the biometric fingerprints are not associated with the same user.

Aspect 11. A system comprising: a processor; and a non-transitory memory storing computer-readable instructions, wherein the instructions, when executed by the processor, is effective to cause the processor to perform operations comprising: receiving behavioral data from a user from a user device, wherein the behavioral data includes behavioral biometrics of the user obtained from one or more sensors of the user device when the user is performing an interaction with a service executing on the user device; comparing the behavioral data and a biometric fingerprint associated with a user profile; and generating, based on the comparison between the behavioral data and the biometric fingerprint, a score indicative of a likelihood that an identity of the user is associated with the user profile.

Aspect 12. The system of aspect 11, wherein the instructions, when executed by the processor, is effective to cause the processor to further perform operations comprising: requiring the user to perform additional security measures when the score is below a threshold score.

Aspect 13. The system of any of aspects 11 or 12, wherein the instructions, when executed by the processor, is effective to cause the processor to further perform operations comprising: receiving a successful authentication response to the additional security measures from the user device; determining, based on the successful authentication response to the additional security measures, that the user is associated with the user profile; and updating the biometric fingerprint with the behavioral data to generate an updated biometric fingerprint.

Aspect 14. The system of any of aspects 11-13, wherein the biometric fingerprint is based on additional behavioral data from the user, wherein the additional behavioral data includes additional behavioral biometrics of the user obtained from the one or more sensors of the user device when the user is performing an additional interaction with another service.

Aspect 15. The system of any of aspects 11-14, wherein the user device is a new device that the user has not used to interact with the service before, wherein the instructions, when executed by the processor, is effective to cause the processor to further perform operations comprising: determining that the identity of the user is associated with the user profile; and updating a device fingerprint with device data of the user device, wherein the device data includes identifying information about the user device.

Aspect 16. The system of any of aspects 11-15, wherein the instructions, when executed by the processor, is effective to cause the processor to further perform operations comprising: granting access to the user without requiring the user to perform additional security measures when the score is above a threshold score.

Aspect 17. The system of any of aspects 11-16, wherein the interaction is associated with a first user account, wherein the instructions, when executed by the processor, is effective to cause the processor to further perform operations comprising: receiving additional behavioral data from the user, wherein the additional behavioral data includes additional behavioral biometrics of the user obtained from one or more sensors of the user device when the user is performing an additional interaction associated with a second user account; and determining, based on the additional biometric data and the biometric fingerprint, that the user is associated with both the first user account and the second user account.

Aspect 18. The system of any of aspects 11-17, wherein the instructions, when executed by the processor, is effective to cause the processor to further perform operations comprising: receiving device data from the user device while the user is performing the interaction with the service executing on the user device, wherein the device data includes identifying information about the user device; comparing the device data and a device fingerprint associated with the user device; and determining, based on the comparison between the device data and the device fingerprint, whether the user device is a device historically used by the user.

Aspect 19. The system of any of aspects 11-18, wherein the instructions, when executed by the processor, is effective to cause the processor to further perform operations comprising: requiring the user to perform additional security measures based on a determination that the user device is not a device historically used by the user.

Aspect 20. The system of any of aspects 11-19, wherein the instructions, when executed by the processor, is effective to cause the processor to further perform operations comprising: training a machine learning model configured to receive the behavioral data and the biometric fingerprint and output the score indicative of the likelihood that the identity of the user is associated with the user profile, the training comprising: providing training behavioral data inputs to the machine learning model; providing training biometric fingerprints; and incrementing an output score when the behavioral data and the biometric fingerprints are associated with a same user and decrementing the output score when the behavioral data and the biometric fingerprints are not associated with the same user.

Aspect 21. A non-transitory computer-readable medium comprising instructions stored thereon, wherein the instructions, when executed by a processor, are effective to cause the processor to perform operations comprising: receiving behavioral data from a user from a user device, wherein the behavioral data includes behavioral biometrics of the user obtained from one or more sensors of the user device when the user is performing an interaction with a service executing on the user device; comparing the behavioral data and a biometric fingerprint associated with a user profile; and generating, based on the comparison between the behavioral data and the biometric fingerprint, a score indicative of a likelihood that an identity of the user is associated with the user profile.

Aspect 22. The non-transitory computer-readable medium of aspect 21, wherein the instructions, when executed by a processor, are effective to cause the processor to further perform operations comprising: requiring the user to perform additional security measures when the score is below a threshold score.

Aspect 23. The non-transitory computer-readable medium of any of aspects 21 or 22, wherein the instructions, when executed by a processor, are effective to cause the processor to further perform operations comprising: receiving a successful authentication response to the additional security measures from the user device; determining, based on the successful authentication response to the additional security measures, that the user is associated with the user profile; and updating the biometric fingerprint with the behavioral data to generate an updated biometric fingerprint.

Aspect 24. The non-transitory computer-readable medium of any of aspects 21-23, wherein the biometric fingerprint is based on additional behavioral data from the user, wherein the additional behavioral data includes additional behavioral biometrics of the user obtained from the one or more sensors of the user device when the user is performing an additional interaction with another service.

Aspect 25. The non-transitory computer-readable medium of any of aspects 21-24, wherein the user device is a new device that the user has not used to interact with the service before, wherein the instructions, when executed by a processor, are effective to cause the processor to further perform operations comprising: determining that the identity of the user is associated with the user profile; and updating a device fingerprint with device data of the user device, wherein the device data includes identifying information about the user device.

Aspect 26. The non-transitory computer-readable medium of any of aspects 21-25, wherein the instructions, when executed by a processor, are effective to cause the processor to further perform operations comprising: granting access to the user without requiring the user to perform additional security measures when the score is above a threshold score.

Aspect 27. The non-transitory computer-readable medium of any of aspects 21-26, wherein the interaction is associated with a first user account, wherein the instructions, when executed by a processor, are effective to cause the processor to further perform operations comprising: receiving additional behavioral data from the user, wherein the additional behavioral data includes additional behavioral biometrics of the user obtained from one or more sensors of the user device when the user is performing an additional interaction associated with a second user account; and determining, based on the additional biometric data and the biometric fingerprint, that the user is associated with both the first user account and the second user account.

Aspect 28. The non-transitory computer-readable medium of any of aspects 21-27, wherein the instructions, when executed by a processor, are effective to cause the processor to further perform operations comprising: receiving device data from the user device while the user is performing the interaction with the service executing on the user device, wherein the device data includes identifying information about the user device; comparing the device data and a device fingerprint associated with the user device; and determining, based on the comparison between the device data and the device fingerprint, whether the user device is a device historically used by the user.

Aspect 29. The non-transitory computer-readable medium of any of aspects 21-28, wherein the instructions, when executed by a processor, are effective to cause the processor to further perform operations comprising: requiring the user to perform additional security measures based on a determination that the user device is not a device historically used by the user.

Aspect 30. The non-transitory computer-readable medium of any of aspects 21-29, wherein the instructions, when executed by a processor, are effective to cause the processor to further perform operations comprising: training a machine learning model configured to receive the behavioral data and the biometric fingerprint and output the score indicative of the likelihood that the identity of the user is associated with the user profile, the training comprising: providing training behavioral data inputs to the machine learning model; providing training biometric fingerprints; and incrementing an output score when the behavioral data and the biometric fingerprints are associated with a same user and decrementing the output score when the behavioral data and the biometric fingerprints are not associated with the same user.

What is claimed is:

1. A computer-implemented method comprising:
receiving behavioral data from a user from a user device, wherein the behavioral data includes behavioral biometrics of the user obtained from one or more sensors of the user device when the user is performing an interaction with a service executing on the user device;
comparing the behavioral data and a biometric fingerprint associated with a user profile; and
generating, based on the comparison between the behavioral data and the biometric fingerprint, a score indicative of a likelihood that an identity of the user is associated with the user profile.

2. The computer-implemented method of claim 1, further comprising:
requiring the user to perform additional security measures when the score is below a threshold score.

3. The computer-implemented method of claim 2, further comprising:
receiving a successful authentication response to the additional security measures from the user device;
determining, based on the successful authentication response to the additional security measures, that the user is associated with the user profile; and
updating the biometric fingerprint with the behavioral data to generate an updated biometric fingerprint.

4. The computer-implemented method of claim 1, wherein the biometric fingerprint is based on additional behavioral data from the user, wherein the additional behavioral data includes additional behavioral biometrics of the user obtained from the one or more sensors of the user device when the user is performing an additional interaction with another service.

5. The computer-implemented method of claim 1, wherein the user device is a new device that the user has not used to interact with the service before, the method further comprising:
determining that the identity of the user is associated with the user profile; and
updating a device fingerprint with device data of the user device, wherein the device data includes identifying information about the user device.

6. The computer-implemented method of claim 1, further comprising:
granting access to the user without requiring the user to perform additional security measures when the score is above a threshold score.

7. The computer-implemented method of claim 1, wherein the interaction is associated with a first user account, the method further comprising:
receiving additional behavioral data from the user, wherein the additional behavioral data includes additional behavioral biometrics of the user obtained from the one or more sensors of the user device when the user is performing an additional interaction associated with a second user account; and
determining, based on the additional biometric data and the biometric fingerprint, that the user is associated with both the first user account and the second user account.

8. The computer-implemented method of claim 1, further comprising:
receiving device data from the user device while the user is performing the interaction with the service executing on the user device, wherein the device data includes identifying information about the user device;
comparing the device data and a device fingerprint associated with the user device; and
determining, based on the comparison between the device data and the device fingerprint, whether the user device is a device historically used by the user.

9. The computer-implemented method of claim 8, further comprising:
requiring the user to perform additional security measures based on a determination that the user device is not the device historically used by the user.

10. The computer-implemented method of claim 1, further comprising:
training a machine learning model configured to receive the behavioral data and the biometric fingerprint and output the score indicative of the likelihood that the identity of the user is associated with the user profile, the training comprising:
providing training behavioral data inputs to the machine learning model;
providing training biometric fingerprints inputs to the machine learning model; and
incrementing an output score when the behavioral data and the biometric fingerprints are associated with a same user and decrementing the output score when the behavioral data and the biometric fingerprints are not associated with the same user.

11. A system comprising:
a processor; and
a non-transitory memory storing computer-readable instructions, wherein the instructions, when executed by the processor, is effective to cause the processor to perform operations comprising:
receiving behavioral data from a user from a user device, wherein the behavioral data includes behavioral biometrics of the user obtained from one or more sensors of the user device when the user is performing an interaction with a service executing on the user device;
comparing the behavioral data and a biometric fingerprint associated with a user profile; and
generating, based on the comparison between the behavioral data and the biometric fingerprint, a score indicative of a likelihood that an identity of the user is associated with the user profile.

12. The system of claim 11, wherein the instructions, when executed by the processor, is effective to cause the processor to further perform operations comprising:
requiring the user to perform additional security measures when the score is below a threshold score.

13. The system of claim 12, wherein the instructions, when executed by the processor, is effective to cause the processor to further perform operations comprising: receiving a successful authentication response to the additional security measures from the user device;
determining, based on the successful authentication response to the additional security measures, that the user is associated with the user profile; and
updating the biometric fingerprint with the behavioral data to generate an updated biometric fingerprint.

14. The system of claim 11, wherein the biometric fingerprint is based on additional behavioral data from the user, wherein the additional behavioral data includes additional behavioral biometrics of the user obtained from the one or more sensors of the user device when the user is performing an additional interaction with another service.

15. The system of claim 11, wherein the user device is a new device that the user has not used to interact with the service before, wherein the instructions, when executed by the processor, is effective to cause the processor to further perform operations comprising:
determining that the identity of the user is associated with the user profile; and
updating a device fingerprint with device data of the user device, wherein the device data includes identifying information about the user device.

16. A non-transitory computer-readable medium comprising instructions stored thereon, wherein the instructions, when executed by a processor, are effective to cause the processor to perform operations comprising:
receiving behavioral data from a user from a user device, wherein the behavioral data includes behavioral biometrics of the user obtained from one or more sensors of the user device when the user is performing an interaction with a service executing on the user device;
comparing the behavioral data and a biometric fingerprint associated with a user profile; and
generating, based on the comparison between the behavioral data and the biometric fingerprint, a score indicative of a likelihood that an identity of the user is associated with the user profile.

17. The non-transitory computer-readable medium of claim 16, wherein the instructions, when executed by a processor, are effective to cause the processor to further perform operations comprising:
granting access to the user without requiring the user to perform additional security measures when the score is above a threshold score.

18. The non-transitory computer-readable medium of claim 16, wherein the interaction is associated with a first user account, wherein the instructions, when executed by a processor, are effective to cause the processor to further perform operations comprising:
receiving additional behavioral data from the user, wherein the additional behavioral data includes additional behavioral biometrics of the user obtained from the one or more sensors of the user device when the user is performing an additional interaction associated with a second user account; and
determining, based on the additional biometric data and the biometric fingerprint, that the user is associated with both the first user account and the second user account.

19. The non-transitory computer-readable medium of claim 16, wherein the instructions, when executed by a processor, are effective to cause the processor to further perform operations comprising:
receiving device data from the user device while the user is performing the interaction with the service executing on the user device, wherein the device data includes identifying information about the user device;
comparing the device data and a device fingerprint associated with the user device; and
determining, based on the comparison between the device data and the device fingerprint, whether the user device is a device historically used by the user.

20. The non-transitory computer-readable medium of claim 19, wherein the instructions, when executed by the processor, are effective to cause the processor to further perform operations comprising:
requiring the user to perform additional security measures based on a determination that the user device is not a device historically used by the user.
